(19) United States
(12) Patent Application Publication
(10) Pub. No.: US 2002/0044193 A1
(43) Pub. Date: Apr. 18, 2002

(54) Thermal head

(76) Inventor: Norimitsu Sambongi, Chiba-shi (JP)

Correspondence Address: ADAMS & WILKS, 31st Floor, 50 Broadway, New York, NY, 10004, US

(21) Appl. No.: 09/903,596

(22) Filed: Jul. 12, 2001

(30) Foreign Application Priority Data
Jul. 25, 2000 (JP) 2000-223578

(51) Int. Cl. B41J 2/335

(52) U.S. Cl. 347/208

(57) ABSTRACT

When a film thickness of electrodes is increased in order to lower a wiring resistance of the electrodes, printing efficiency is reduced because of an electrode step produced in the heating element portion, a two-stage electrode structure in which a film thickness of the electrodes near resistors interfering with a print paper is made small such that the influence due to a step is not caused and in which a film thickness of other electrode portions is made large such that a sufficient wiring resistance can be obtained.

### BACKGROUND OF THE INVENTION

1. Field of the invention

The present invention relates to a thermal head used in, for example, a compact and portable recording device, a facsimile, a printing apparatus for a ticket and a receipt.

2. Description of the Related Art

An example of a conventional thin film thermal head is shown in FIG. 4. Generally, with respect to the thin film thermal head, a glaze layer 12 is formed on an insulating substrate 11 and a large number of heating resistors 13 are arranged thereon. Electrodes for supplying power to each of the heating resistors are connected with both sides thereof. A common electrode 14 as one electrode is connected with a high potential side. A separate electrode 15 as the other electrode is connected with a ground side through an driver IC having a switching circuit for selectively heating the heating resistors according to a print signal, and further connected with an external input terminal. A protective film 16 for covering a portion of the heating resistors and a portion of the electrodes is formed in the upper layer of the heating resistors and the electrodes.

Printing by the thermal head is made as follows. That is, a print paper 17 is pressed to a heating element portion by a round-bar-shaped rubber platen 18 located above the heating resistors and having a constant diameter and a constant hardness, and is rotated with this pressed state. Then, heat produced by the heating resistors is transferred to the protective film layer while the print paper is run on the heating element by friction force between the surface of the platen and the rear surface of the print paper. Thus, the heat reaches the print paper to thereby enable coloring.

With respect to such a thin film thermal head, in order to sufficiently supply power supplied from an external power source of the thermal head to the heating resistors, in consideration of a wiring resistance from the external input terminal to the heating resistors, it is designed to minimize an occurrence of a voltage drop. In particular, in the case of the thermal head in which a resistance value of the heating resistors is low, a ratio of the wiring resistance value of the electrodes to the resistance value of the heating resistors becomes larger and thus power loss becomes larger. This needs to be fully considered in designing such a thermal head.

Specifically, major considerations are the ON resistance value of the driver IC having the switching circuit for selectively heating the resistors, the wiring resistance value of the electrode from the driver IC until the heating resistors, and the wiring resistance value of the electrodes from the heating resistors to a ground terminal.

Generally, the driver IC has individual characteristic depending on its type and the characteristic is specified by the type of the drive IC selected in a design stage. Thus, there is almost no room for selection in the design. However, with respect to the wiring resistance of the electrode, when the film thickness of the electrode is designed based on an electrode width determined by a physical area that it can occupy in the thermal head, a suitable wiring resistance value can be selected.

Therefore, to reduce the wiring resistance value of the electrode, the film thickness of the electrodes may be made large. However, when a step is caused in both sides of the heating resistors by increasing the thickness of the electrodes, an air gap due to the step between the print paper run on the resistors and the heating resistors becomes larger. Thus, there is a problem in that efficiency of thermal transfer from the thermal head to the print paper is decreased.

Therefore, when the film thickness of the electrode is increased to a certain thickness, printing efficiency is improved. However, when the film thickness of the electrode is further increased, there is a problem in that printing efficiency is reduced.

### SUMMARY OF THE INVENTION

Thus, in order to solve the above problems, the present invention is to provide a thin film thermal head in which a reduction in the printing efficiency due to the electrode step in the heating resistors portion can be suppressed while the wiring resistance of the electrode is lowered.

In order to solve the above problems, the present invention provides a two-stage electrode structure in which the film thickness of the electrodes near the heating resistors, which interferes with the print paper, is small such that the influence due to the step is not caused and in which the film thickness of the other electrode portions is made large such that sufficient wiring resistance can be obtained.

### BRIEF DESCRIPTION OF THE DRAWINGS

In the accompanying drawings:

FIG. 1 is a cross sectional view of a thermal head of the present invention;

FIG. 2(A) to FIG. 2(E) are views showing a manufacturing process by a method of performing film formation twice;

FIG. 3(A) to FIG. 3(E) are views showing a manufacturing process by a method of performing etching twice; and

FIG. 4 is a cross sectional view of a conventional thermal head.

### DETAILED DESCRIPTION OF THE PREFERED EMBODIMENTS

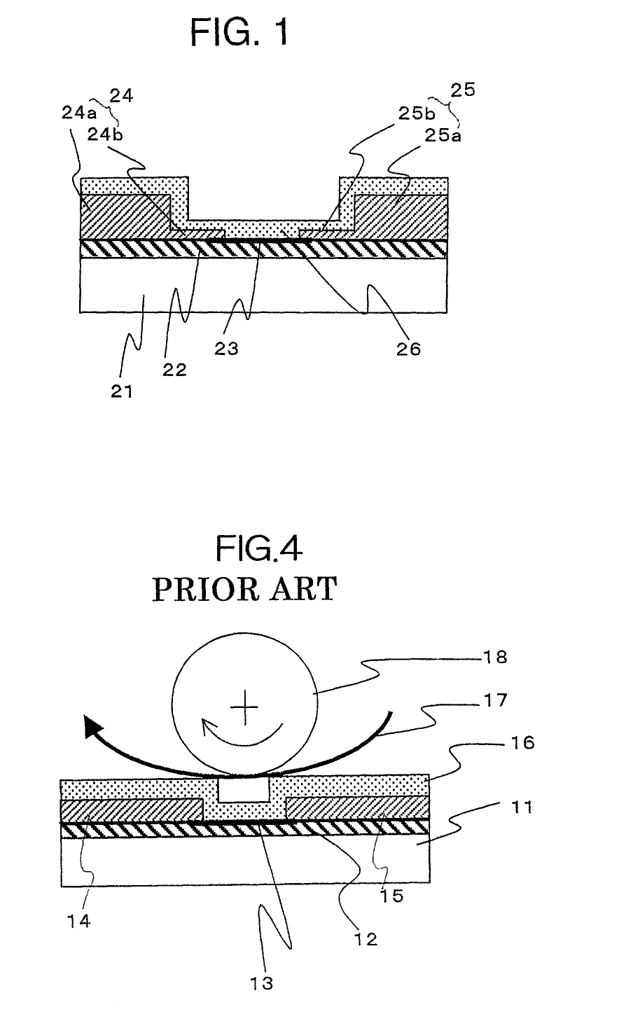

Hereinafter, an embodiment of the present invention will be described based on FIGS. 1 to 3.

FIG. 1 is a cross sectional view of a thermal head of the present invention. As shown in FIG. 1, with respect to the thermal head, a glaze layer 22 which has a function as a thermal insulating layer and is made of a glass system material is formed on a ceramic substrate 21. A plurality of heating resistors 23 which contains Ta, Si, or the like as its main components and made of a nitride and oxide system material are formed on the glaze layer at predetermined intervals. Electrodes for supplying power to each of the heating resistors, which are made of a metal system material such as aluminum, are connected with both sides thereof. A common electrode 24 as one electrode is connected with a high potential side. A separate electrode 25 as the other electrode is connected with a ground side through an driver IC having a switching circuit for selectively heating the heating resistors according to a print signal, and is further connected with an external input terminal.

The common electrode 24 and the separate electrode 25, which are connected with the heating resistors 23, are both constructed by a thin electrode 24b,25b which is located near the heating resistors 23 in a position that is one step lower and a thick electrode 24a,25a as the other electrode portion. A protective film 26 for covering a portion of the heating resistors and a portion of the electrodes is formed in the uppermost layer.

(Manufacturing Process)

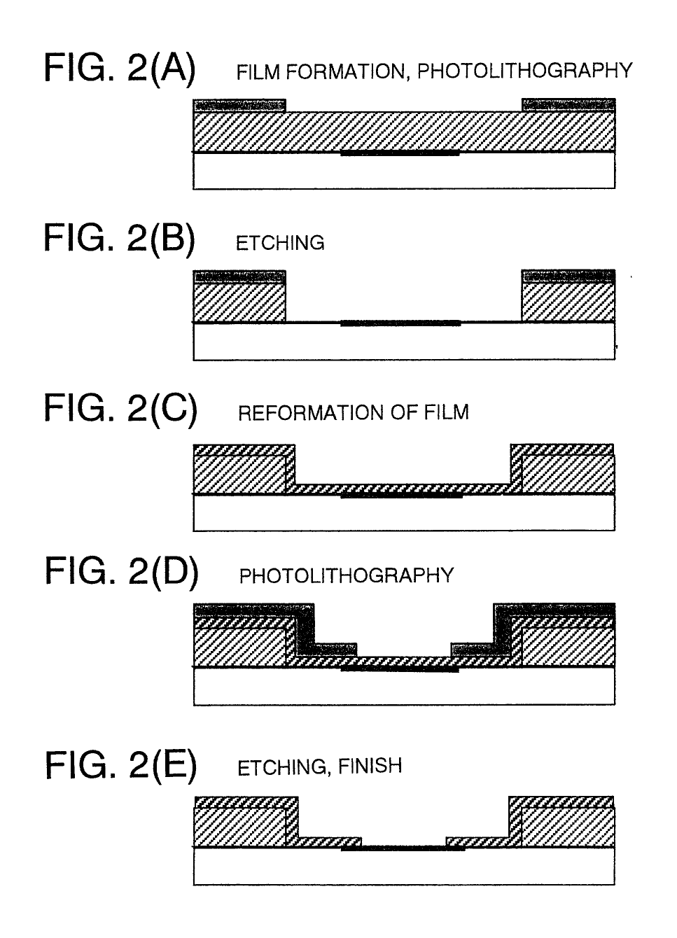

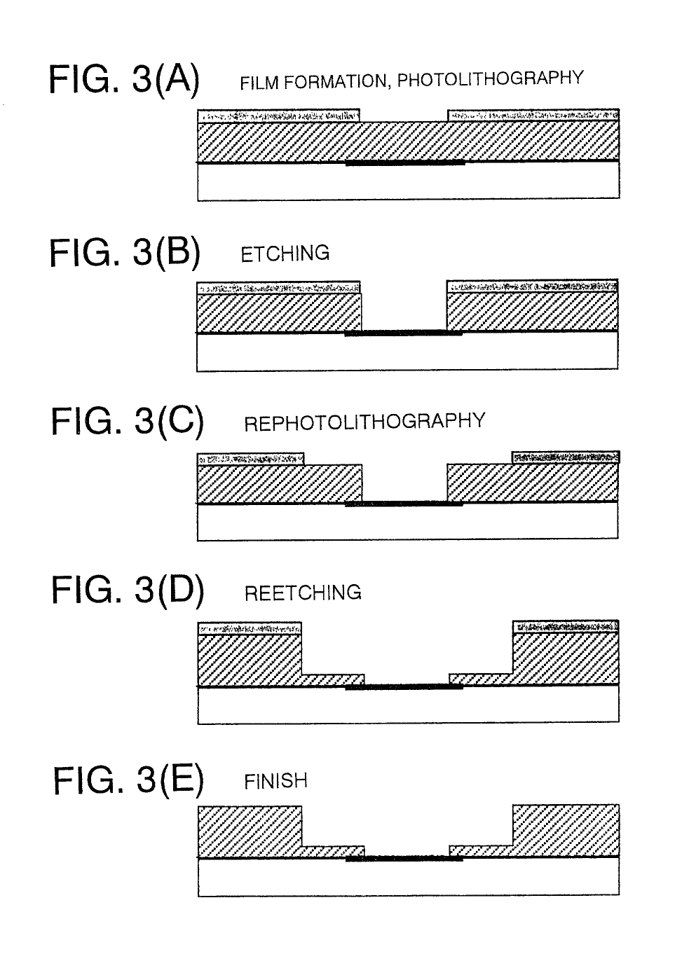

Hereinafter, the embodiment will be further described in details referring to one example of a process for manufacturing the above thermal head. With respect to the formations of the glaze layer, the undercoat layer, the heating resistors, and the protective film layer as the uppermost layer on the ceramic substrate, since a method that is conventionally well known is used, the detailed description is omitted here. Hereinafter, a typical example of a process for manufacturing two-stage electrodes will be described with reference to FIGS. 2 and 3.

As the example of the manufacturing process, (1) a manufacturing process by a method of performing film formation twice and (2) a manufacturing process by a method of performing etching twice will be described. In the process (1), after the thick electrode is formed by sputtering and photolithography, the thin electrode is again formed through the same process. In the process (2), first, the film formation is performed once by sputtering, and then the thin electrode portion is formed by repeating photolithography and etching twice.

The example of (1) the manufacturing process by the method of performing the film formation twice is shown in FIG. 2(A) to FIG. 2(E).

First, aluminum film is formed by sputtering with a film thickness of the thick electrode, which is required for the wiring resistance of the electrode, and an aluminum electrode is patterned by photolithography FIG. 2 (a) and etching FIG. 2 (b) to form the thick electrode within a region that is apart from the heating resistors by a certain distance.

After that, aluminum film is again formed by sputtering with a film thickness required as the thin electrode FIG. 2 (c). Then, the thin electrode is connected with the heating resistors by photolithography FIG. 2 (d) and patterned by etching so as to overlap with the thick electrode described above to form the thin electrode FIG. 2 (e).

The example of (2) a manufacturing process by a method of performing etching twice is shown in FIG. 3(A) to FIG. 3(E).

First, aluminum film is formed by sputtering with a film thickness of the thick electrode, which is required for the wiring resistance of the electrode, and an aluminum electrode is patterned by photolithography FIG. 3 (a) and etching FIG. 3 (b) and thus the thick electrode is formed so as to connect with the heating resistors.

After that, a portion of the electrode is masked by photolithography within a region that is apart from the heating resistors by a certain distance FIG. 3 (c). Then, etching is performed FIG. 3 (d) with respect to certain portions of the entire film thickness to form the thin electrode FIG. 3 (e).

As described above, in this embodiment, aluminum is used as an electrode material. However, another metal material may be used. In addition, in the manufacturing process by the method of performing the film formation twice, different kinds of materials can be used for the thick electrode and the thin electrode.

In such a two-stage electrode structure, a film thickness of the thick electrode is generally about 1ìm to 3ìm. On the other hand, when the thickness of the thin electrode is decreased beyond this thickness, the electrode step near the heating element is reduced and thus the contact between the print paper and the top of the heating resistors is improved. Therefore, the printing efficiency is improved.

However, when the film thickness of the thin electrode is made smaller than a certain thickness, the improvement of the efficiency is no longer obtained. When the thin electrode is further thinned, the efficiency tends to deteriorate. The reason for this is as follows. That is, since the wiring resistance value of the thin electrode portion becomes larger, large electrode drop is caused in this portion and thus the printing efficiency is conversely reduced.

Also, when the film thickness of the electrode is too small, a variation in the film thickness by sputtering becomes larger and patterning is unstable. Thus, it is desirable that a film thickness of the thin electrode is in a range of 0.1ìm to 0.5ìm.

Also, a region in which the print paper is interfered with the heating resistors portion of the thermal head changes depending on a type and a thickness of the print paper, a diameter and a hardness of the platen made of rubber for pressing the print paper to the thermal head, and pressing force. However, the region is in the range of about 0.5 mm to 2 mm from the center position of the heating resistors to both sides thereof. Thus, it is desirable that a region of the thin electrode is in a range of 0.5 mm to 2 mm from the ends of the electrode near the heating element portion.

As described above, according to the present invention, there is an effect that the interference between the print paper and the heating resistors portion is alleviated and thus the printing efficiency is improved without deteriorating the electrode wiring resistance in the thermal head.

What is claimed is:

1. A thermal head characterized in that a thickness of electrodes within a predetermined distance from ends of the electrodes that are connected with both sides of a heating element is thinner than a thickness of other portions.

2. A thermal head according to claim 1, characterized in that a thickness of the ends of the electrodes is 0.1ìm to 0.5ìm.

3. A thermal head according to claim 1, characterized in that a region in which the ends of the electrodes become thinner is in a range of 0.5 mm to 2 mm.
